(19) United States
(12) Patent Application Publication
(10) Pub. No.: US 2026/0027950 A1
(43) Pub. Date: Jan. 29, 2026

(54) TECHNIQUES FOR PREDICTIVE SUPERVISORY ENERGY MANAGEMENT IN FUEL CELL ELECTRIC VEHICLES

(71) Applicant: FCA US LLC, Auburn Hills, MI (US)

(72) Inventors: Ali Sina Shojaei, Auburn Hills, MI (US); Feisel Weslati, Auburn Hills, MI (US); Hanane Hemi, Auburn Hills, MI (US)

(21) Appl. No.: 18/783,677

(22) Filed: Jul. 25, 2024

(51) Int. Cl. B60L 58/40; G06Q 50/06

(52) U.S. Cl. CPC B60L 58/40; G06Q 50/06

(57) ABSTRACT

A predictive supervisory energy management technique for a fuel cell electric vehicle (FCEV) involves monitoring driver inputs to the FCEV, states of the FCEV, and external inputs affecting the FCEV along a defined route, predicting energy consumption by a high voltage system of the FCEV across a future prediction horizon based on the driver inputs, the states of the FCEV, and the external inputs affecting the determining weighting factors and boundary conditions for a cost function for the energy consumption by the high voltage system of the FCEV, evaluating the cost function based on the determined weighting factors, boundary conditions, and the predicted energy consumption by the high voltage system across the future prediction horizon, and optimally controlling a fuel cell system and a high voltage battery system of the high voltage system of the FCEV based on the evaluation of the cost function.

### FIELD

The present application generally relates to fuel cell electric vehicles (FCEVs) and, more particularly, to techniques for predictive supervisory energy management in FCEVs.

### BACKGROUND

A fuel cell electric vehicle (FCEV) includes a fuel cell system that is configured to perform a chemical conversion of a fuel (e.g., hydrogen) to generate electrical energy, which is then used to recharge a high voltage battery system for powering one or more electric traction motors of the FCEV for propulsion. Fuel cell systems are expensive and therefore it is important to utilize them as best as possible. More specifically, a goal is to have less transients in the fuel cell system to maximize the efficiency and life of the fuel cell system. Conventional techniques for controlling the fuel cell system include (i) reactive, rule-based techniques and (ii) optimization-based techniques. The rule-based techniques, being reactive, are susceptible to more/larger transients of the fuel cell system. The optimization-based techniques, on the other hand, are only optimized for driving the FCEV and are not otherwise tunable. Accordingly, while such conventional FCEV control techniques do work for their intended purpose, there exists an opportunity for improvement in the relevant art.

### SUMMARY

According to one example aspect of the invention, a predictive supervisory energy management system for a fuel cell electric vehicle (FCEV) is presented. In one exemplary implementation, the predictive supervisory energy management system comprises a set of sensors configured to monitor driver inputs to the FCEV, states of the FCEV, and external inputs affecting the FCEV along a defined route, and a control system connected to the set of sensors and configured to predict energy consumption by a high voltage system of the FCEV across a future prediction horizon based on the driver inputs, the states of the FCEV, and the external inputs affecting the FCEV, the high voltage system comprising a high voltage battery system and a fuel cell system, determine weighting factors and boundary conditions for a cost function for the energy consumption by the high voltage system of the FCEV, evaluate the cost function based on the determined weighting factors, boundary conditions, and the predicted energy consumption by the high voltage system across the future prediction horizon, and optimally control the fuel cell system and the high voltage battery system based on the evaluation of the cost function.

In some implementations, the cost function is defined as follows:

$$J = \sum ( {α}_{1} {f}_{1} ( {P}_{b} ) + {α}_{2} {f}_{2} ( {P}_{fc} ) + {α}_{3} {f}_{3} ( {P}_{net} \cdot {P}_{E M}^{d} ) + {α}_{4} {f}_{4} ( ζ \cdot {ζ}_{min}^{*} ) + {α}_{5} {f}_{5} ( ζ \cdot {ζ}_{max}^{*} ) + {α}_{6} {f}_{6} ( F C W U ) ) Δ t + {α}_{7} {f}_{7} ( {ζ}_{f} \cdot {ζ}_{f}^{*} ) + {α}_{8} {f}_{8} ( L H {T}_{f} , LH {T}_{f}^{*} ) \qquad ( 1 )$$

where J represents the cost function with weighting factors α₁ to α₈ for components f₁ to f₈, P_{b} and P_{fc} represent a battery terminal power and a fuel cell output power, respectively,

$${P}_{EM}^{d}$$

represents a desirable power of one or more electric motors of the FCEV, Pₙₑₜ represents a net power of the high voltage battery system, the fuel cell system, and a set of accessory systems, ζ represents a state of charge (SOC) of the high voltage battery system,

$${ζ}_{min}^{*} and {ζ}_{max}^{*}$$

represent target minimum and maximum bounds of ζ, FCWU represents a cost of waking up and thermally managing the fuel cell system, ζ_{f} and

$${ζ}_{f}^{*}$$

represent a final remaining SOC and its target, respectively, and LHT_{f} and

$${LHT}_{f}^{*}$$

represent a final remaining level of fuel cell system fuel and its target, respectively.

In some implementations, the control system is configured to apply numerical and statistical methods to predict a vehicle state evolution through the future prediction horizon, wherein the predicted vehicle state evolution is used in the evaluating of the cost function. In some implementations, the driver inputs, the states of the FCEV, and the external inputs affecting the FCEV include both historical and real-time information. In some implementations, the driver inputs include (i) route plan, (ii) accelerator pedal position, (iii) vehicle stoppage intervals, (iv) accessory loads, (v) fuel cell system refueling and battery charging patterns, (vi) vehicle driving mode, (vii) departure time, (viii) scheduled charging, and (ix) scheduled conditioning. In some implementations, the states of the FCEV include (i) subsystem temperatures, (ii) subsystem efficiencies, (iii) remaining battery energy, (iv) battery state of health (SOH), (v) accumulated vehicle run time, (vi) accumulated vehicle energy consumption, and/or (vii) vehicle weight and payload. In some implementations, the external inputs affecting the FCEV include (i) geographical location, (ii) route topological information, (iii) climatic information, (iv) traffic information, and (v) location of battery charging and H2 refueling stations.

In some implementations, the control system is further configured to determine a usage scenario for optimally controlling the FCEV and the energy consumption prediction, the weighting factors and boundary conditions determination, and the cost function evaluation are all performed based on the determined usage scenario. In some implementations, the usage scenario is one of (i) maximizing regenerative braking capability, (ii) maintaining SOC for key-off functions, (iii) optimizing vehicle-to-load and/or vehicle-to-home functions, (iv) blending fuel cell system fuel and battery SOC based on availability of charging and refueling stations, or (v) managing trade-off between fuel cell system warm-up and other thermal conditioning loads.

According to another example aspect of the invention, a predictive supervisory energy management method for an FCEV is presented. In one exemplary implementation, the predictive supervisory energy management method comprises monitoring, by a set of sensors of the FCEV, driver inputs to the FCEV, states of the FCEV, and external inputs affecting the FCEV along a defined route, predicting, by a control system of the FCEV, energy consumption by a high voltage system of the FCEV across a future prediction horizon based on the driver inputs, the states of the FCEV, and the external inputs affecting the FCEV, the high voltage system comprising a high voltage battery system and a fuel cell system, determining, by the control system, weighting factors and boundary conditions for a cost function for the energy consumption by the high voltage system of the FCEV, evaluating, by the control system, the cost function based on the determined weighting factors, boundary conditions, and the predicted energy consumption by the high voltage system across the future prediction horizon, and optimally controlling, by the control system, the fuel cell system and the high voltage battery system based on the evaluation of the cost function.

In some implementations, the cost function is defined as follows:

$$J = \sum ( {α}_{1} {f}_{1} ( {P}_{b} ) + {α}_{2} {f}_{2} ( {P}_{fc} ) + {α}_{3} {f}_{3} ( {P}_{net} \cdot {P}_{EM}^{d} ) + {α}_{4} {f}_{4} ( ζ \cdot {ζ}_{min}^{*} ) + {α}_{5} {f}_{5} ( ζ \cdot {ζ}_{max}^{*} ) + {α}_{6} {f}_{6} ( FCWU ) ) Δ t + {α}_{7} {f}_{7} ( {ζ}_{f} \cdot {ζ}_{f}^{*} ) + {α}_{8} {f}_{8} ( {LHT}_{f} , {LHT}_{f}^{*} ) , \qquad ( 1 )$$

where J represents the cost function with weighting factors α₁ to α₈ for components f₁ to f₈, P_{b} and P_{fc} represent a battery terminal power and a fuel cell output power, respectively,

$${P}_{EM}^{d}$$

represents a desirable power of one or more electric motors of the FCEV, Pₙₑₜ represents a net power of the high voltage battery system, the fuel cell system, and a set of accessory systems, ζ represents a state of charge (SOC) of the high voltage battery system,

$${ζ}_{min}^{*} and {ζ}_{max}^{*}$$

represent target minimum and maximum bounds of ζ, FCWU represents a cost of waking up and thermally managing the fuel cell system, ζ_{f} and

$${ζ}_{f}^{*}$$

represent a final remaining SOC and its target, respectively, and LHT_{f} and

$${LHT}_{f}^{*}$$

represent a final remaining level of fuel cell system fuel and its target, respectively.

In some implementations, the predictive supervisory energy management method further comprises applying, by the control system, numerical and statistical methods to predict a vehicle state evolution through the future prediction horizon, wherein the predicted vehicle state evolution is used by the control system in the evaluating of the cost function. In some implementations, the driver inputs, the states of the FCEV, and the external inputs affecting the FCEV include both historical and real-time information. In some implementations, the driver inputs include (i) route plan, (ii) accelerator pedal position, (iii) vehicle stoppage intervals, (iv) accessory loads, (v) fuel cell system refueling and battery charging patterns, (vi) vehicle driving mode, (vii) departure time, (viii) scheduled charging, and (ix) scheduled conditioning. In some implementations, the states of the FCEV include (i) subsystem temperatures, (ii) subsystem efficiencies, (iii) remaining battery energy, (iv) battery state of health (SOH), (v) accumulated vehicle run time, (vi) accumulated vehicle energy consumption, and/or (vii) vehicle weight and payload. In some implementations, the external inputs affecting the FCEV include (i) geographical location, (ii) route topological information, (iii) climatic information, (iv) traffic information, and (v) location of battery charging and H2 refueling stations.

In some implementations, the control system is further configured to determine a usage scenario for optimally controlling the FCEV and the energy consumption prediction, the weighting factors and boundary conditions determination, and the cost function evaluation are all performed based on the determined usage scenario. In some implementations, the usage scenario is one of (i) maximizing regenerative braking capability, (ii) maintaining SOC for key-off functions, (iii) optimizing vehicle-to-load and/or vehicle-to-home functions, (iv) blending fuel cell system fuel and battery SOC based on availability of charging and refueling stations, or (v) managing trade-off between fuel cell system warm-up and other thermal conditioning loads.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a fuel cell electric vehicle (FCEV) having an example predictive supervisory energy management system according to the principles of the present application; and

FIG. 2 is a flow diagram of an example predictive supervisory energy management method for a FCEV according to the principles of the present application.

### DESCRIPTION

A key roadblock to sustainable market penetration of all-electric battery electric vehicles (BEVs) is customer concerns about limited range (“range anxiety”) combined with the relative slowness of battery charging. Many major automotive manufacturers have therefore started to adopt fuel cell electric vehicles (FCEVs) as an alternative that can remedy both concerns. This is due to the development of safe onboard storage of fuel (e.g., hydrogen, or H2) at the quantities that can provide meaningful range, and H2 refueling times that are comparable to that of conventional vehicle refueling (gasoline, diesel, etc.). As discussed above, however, fuel cell systems are expensive. Thus, justifying the additional cost of the fuel cell system depends significantly on implementing a coordinated control strategy for the fuel cell system and the high voltage battery system to ensure that not only are the best energy efficiency, highest range, and hence the lowest total running costs realized, but also maximal benefits for other tangential attributes of the vehicle are achieved.

Several practical considerations apply to the control of fuel cell systems. Common fuel cell systems have exhibited sluggish power generation dynamics compared to (e.g., lithium-ion, or Li-ion) type battery packs or systems. In addition, the durability of typical fuel cell systems is negatively affected by the number of startup and shut down events (also referred to herein as “transients”). Also, once started up, the fuel cell system requires strict thermal management as well as shut-down processes. As a result, minimizing the number of fuel cell system start-stop events, ensuring smooth blending of power output between the battery and the fuel cell system, and meeting possible trade-offs between the thermal management of the fuel cell system and other consumer of thermal energy are among the criteria that need to be considered in designing appropriate supervisory energy management algorithms for FCEVs.

Inclusion of new supplementary functions such as vehicle-to-load (V2L) and vehicle-to-home (V2H) charging or energy off-loading in vehicles, including FCEVs, has increased the interaction of customers with the energy management strategy of the vehicle. These new functions and the increases customer interaction further increases the criticality of an energy management strategy that can enable consistent vehicle operation under a range of operating conditions and usage scenarios. Achieving this requires information about the operating conditions of the vehicle, prediction of the future states of the vehicle, and access to external information such as the route and climatic conditions, combined with a deep understanding of the vehicle-level attributes effected by energy management strategy. As previously discussed herein, conventional methods of supervisory energy management for FCEVs can be categorized into (i) reactive, rule-based and (ii) optimization-based methods.

Conventional rule-based methods include setting pre-defined boundary limits for the battery state of charge (SOC) and applying charge depleting and charge sustaining strategies based on the SOC. In these strategies, using battery power is prioritized when the battery SOC is above the predefined limit, whereas the fuel cell system will be used once the SOC drops in an effort to maintain the fuel cell within a predefined window. A set of additional rules could be used to wake up the fuel cell in case of consistently high power demands from the customer while other sets of rules are applied to prevent frequent fuel cell system startups.

Conventional optimization-based methods typically use a cost function comprising a representation of energy consumption, SOC limit and component durability limits. These cost functions are typically solved in a deterministic fashion or based on abstract extrapolation of the vehicle operating trends, which basically assumes that the current power request will remain valid for a period of time. By solving the optimization problem, near-optimal control of the fuel cell system and the high voltage battery system is achieved over the extrapolation horizon, although the global results will be sub-optimal in nature. Another short coming of the existing methods in this second category is that the weighting of the cost function terms are predefined, because tuning the weighting relies on long term prediction of the operating conditions, which has been absent from these existing methods.

There are a number of drawbacks to these conventional methods of supervisory energy management. First, the prediction is limited to extrapolation of current operating conditions to short future horizons and therefore the ability of long-term decision making is lacking. These conventional methods are also limited in scope to energy management during driving (on-road) operation of the vehicle. Next, dynamic tuning of terminal conditions (reserve SOC, and reserve H2 level, etc.) based on requirement of key-off functions or the weighting factors is neglected. Instead, blending fuel cell and battery power is only based on total energy consumption during driving while the terminal SOC and hydrogen limits are predefined to maintain minimum drivability. Further, these conventional methods do not (i) include the availability of charging or fuel stations in tunning of the energy management strategy, (ii) account for road topology to maximize regen capacity in downhill movement, or (iii) account for trade-off between the thermal management of the fuel cell system and other consumers of thermal energy when controlling fuel cell system wakeup.

As a result, the improved predictive supervisory energy management techniques for FCEVs are presented herein. These techniques enable near-optimal performance of the FCEV with respect to several vehicle-level attributes. The techniques utilize algorithms that are partially or wholly hosted on the in-built FCEV control units and define the strategy of controlling the energy storage systems of the FCEV, namely the fuel cell system and the high voltage battery system. In doing so, these algorithms acquire and process real-time and historical information, such as the states of FCEV subsystems, the operation of the FCEV, driver inputs, and external inputs. These techniques predict the future operating conditions of the FCEV and blend the fuel cell system and high voltage battery system power outputs to optimize the FCEV operation across different attributes including but not limited to range, drive performance, running cost, and component health.

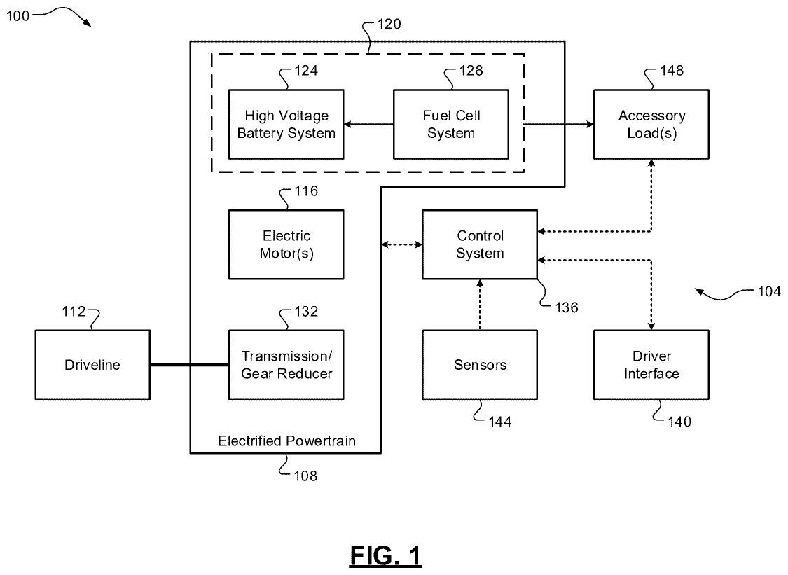

Referring now to FIG. 1, a functional block diagram of an FCEV 100 having an example predictive supervisory energy management system 104 according to the principles of the present application is illustrated. The FCEV 100 (also “vehicle 100”) includes an electrified powertrain 108 configured to generate and transfer drive torque to a driveline 112 for vehicle propulsion. The electrified powertrain 108 includes one or more electric motors 116 (e.g., three-phase electric traction motors) powered by a high voltage system 120. The high voltage system 120 includes both a high voltage battery pack or system 124 (also “battery system 124”) and a fuel cell system 128 (e.g., an H2 fuel cell system). The electric motor(s) 116 are configured to generate drive torque that is transferred to the driveline 112 via an optional transmission or gear reducer 132. In some implementations, the electrified powertrain 108 could further include other non-illustrated components, such as an internal combustion engine and a DC-DC converter for supporting a low voltage battery (e.g., a 12V battery system). A controller or control system 136 is configured to control operation of the electrified vehicle 100, which primarily includes controlling the electrified powertrain 108 to generate a desired amount of drive torque to satisfy a driver torque request provided by a driver via a driver interface 140 (e.g., an accelerator pedal).

The control system 136 is also configured to receive measurements of various operating parameters of the FCEV 100 from a plurality of sensors 144, such as, but not limited to, speeds/accelerations, pressures, temperatures, and electrical parameters (current, voltage, etc.). The sensors 144 could also include a navigation/maps system capable of providing locations of external charging/refueling stations and their associated parameters (e.g., cost per unit of energy). The FCEV 100 also includes a set of accessory loads or systems 148 (an air conditioning system, an electric air compressor, an electric coolant heater, etc.) that are each configured to be powered by the high voltage system 120 or, alternatively, via the low voltage system (e.g., a 12V battery system). The control system 136 is also configured to perform the predictive supervisory energy management control techniques of the high voltage system 120 according to the principles of the present application.

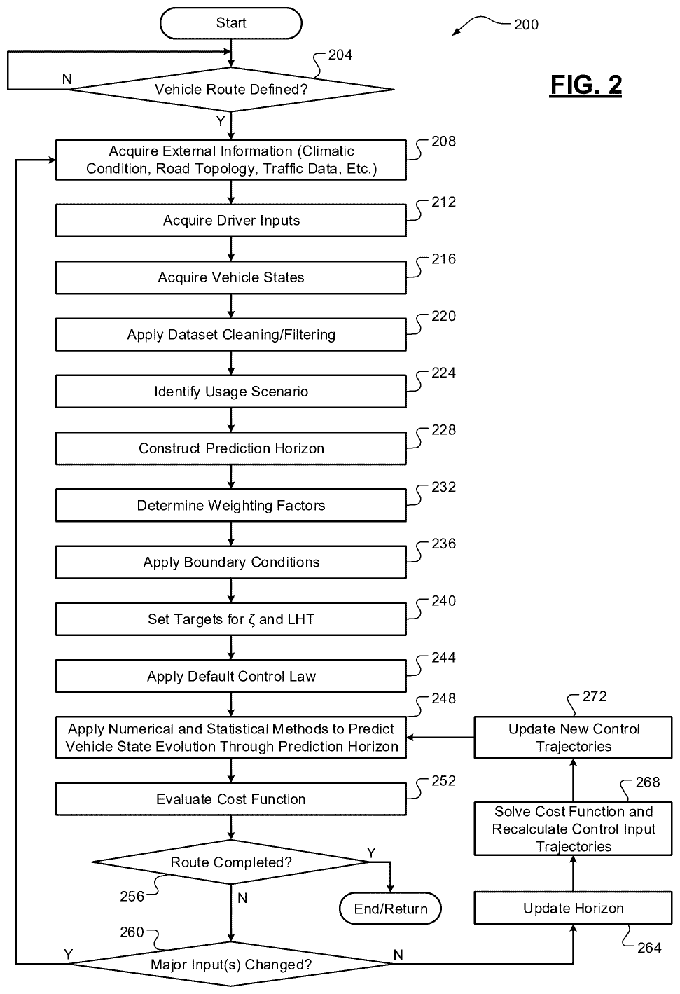

Referring now to FIG. 2, a flow diagram of an example predictive supervisory energy management method 200 for an FCEV according to the principles of the present application is illustrated. While the method 200 specifically references the FCEV 100 and its components for descriptive/illustrative purposes, it will be appreciated that the method 200 could be applicable to any suitably configured FCEV. The method 200 begins at 204. At 204, the control system 136 determines whether the route for the FCEV 100 is defined. This could be, for example, a predefined or preset route by a driver of the FCEV 100 (e.g., via the driver interface 140). It will be appreciated that the vehicle route could also be determined/defined in any other suitable manner, such as automatically determined and defined by the control system 136 based on other parameters (e.g., time of day/week and other historical data). It will be appreciated that step 204 could optionally further include determining whether any other suitable preconditions are satisfied, such as the FCEV 100 being fully operational without any malfunctions or faults that would negatively impact or otherwise inhibit the operation. When true, the method 200 proceeds to 208. When false, the method 200 ends or returns to 204.

After 204, the control system 136 begins to acquire real-time or historical information about the states and operation patterns of the FCEV and its subsystems, driver inputs, and external inputs. At 208, the control system 136 acquires external information or inputs (e.g., from the sensors 144). Non-limiting examples of these external inputs include, but are not limited to, (i) geographical location, (ii) route topological information, such as gradient and altitude, (iii) climatic information, (iv) traffic information, and/or (v) location of battery charging and H2 refueling stations (e.g., the cost of energy—electricity costs, H2 costs, etc.—can vary, per unit and/or the availability, depending on a location or region). At 212, the control system 136 retrieves real-time and/or historical driver inputs (e.g., from a local memory of the control system 136). These real-time and historical driver inputs include, but are not limited to, (i) route plan, (ii) accelerator pedal position, (iii) vehicle stoppage intervals, (iv) accessory loads (e.g., air conditioning), (v) H2 refueling and battery charging pattern(s), (vi) driving mode (eco, sport, trailer/tow, etc.), (vii) departure time, (viii) scheduled charging, and/or (ix) scheduled conditioning.

At 216, the control system 136 acquires real-time or historical information about the states of the FCEV 100 and its subsystems (e.g., the high voltage battery system 124). These real-time and historical states include, but are not limited to, (i) subsystem temperatures, (ii) subsystem efficiencies, (iii) remaining battery energy, (iv) battery state of health (SOH), (v) accumulated vehicle run time, (vi) accumulated vehicle energy consumption, and/or (vii) vehicle weight and payload. At optional 220, the control system 136 performs dataset cleaning or filtering could be performed, such as to reduce/eliminate noise and/or to remove/discard duplicative data. At 224, the control system 136 optionally determines or identifies a usage scenario of the fuel cell system 128 by the FCEV 100. The usage scenario could be, but is not limited to, (i) maximizing regenerative braking capability, (ii) maintaining SOC for key-off functions, (iii) optimizing V2L and/or V2H functions, (iv) blending H2 and battery SOC based on availability of charging and fuel stations, or (v) managing trade-off between fuel cell system warm-up and other thermal conditioning loads. These specific usage scenarios will be discussed in greater detail later on.

At 228, based on the real-time and historical information about the states and the operation patterns of the FCEV 100 and its subsystems, driver inputs, and external inputs, a prediction horizon is constructed. At 232, weighting factors (α₁ to α₈) for a cost function are determined. In one exemplary implementation, the supervisory control algorithm minimizes a cost function (J) as shown below, which is composed of eight components (f₁ to f₈):

$$J = \sum ( {α}_{1} {f}_{1} ( {P}_{b} ) + {α}_{2} {f}_{2} ( {P}_{fc} ) + {α}_{3} {f}_{3} ( {P}_{net} \cdot {P}_{EM}^{d} ) + {α}_{4} {f}_{4} ( ζ \cdot {ζ}_{min}^{*} ) + {α}_{5} {f}_{5} ( ζ \cdot {ζ}_{max}^{*} ) + {α}_{6} {f}_{6} ( FCWU ) ) Δ t + {α}_{7} {f}_{7} ( {ζ}_{f} \cdot {ζ}_{f}^{*} ) + {α}_{8} {f}_{8} ( {LHT}_{f} , {LHT}_{f}^{*} ) . \qquad ( 1 )$$

In Equation (1) above, P_{b} and P_{fc} represent the battery terminal power and fuel cell output power respectively;

$${P}_{EM}^{d}$$

represents the desirable power of the electric motor(s) 116, which is in itself a function of the driver inputs and system parameters; Pₙₑₜ represents the net power of the energy producers and consumers, including the battery system 124, the fuel cell system 128, and the accessory systems 148; the 3^{rd} term therefore penalizes the power imbalance with respective to the desirable power of the electric motor(s) 116; ζ represents the battery system SOC or alternatively the state of energy, while

$${ζ}_{min}^{*} and {ζ}_{max}^{*}$$

represent its target minimum and maximum bounds of ζ; the fourth and the fifth terms penalize the deviation of the SOC from its minimum and maximum targets respectively; FCWU denotes the cost of waking up of the fuel cell system 128 which includes the cost of the fuel cell thermal management; ζ_{f} and

$${ζ}_{f}^{*}$$

represent the final remaining SOC and its target respectively; and LHT_{f} and

$${LHT}_{f}^{*}$$

represent the final remaining level of H2 and its target respectively.

As mentioned above, coefficients α₁ to α₈ are the weighting and homogeneity factors. The coefficients α₁ to α₈ and the target limits

$${ζ}_{min}^{*} , {ζ}_{max}^{*} , {ζ}_{f}^{*} and {LHT}_{f}^{*}$$

are determined by the control system 136 in real-time based on prediction of the future operating states of the FCEV 100 at steps 232-240 and, at 244, the control system 136 applies a default control law. The horizon of solving the minimization will be determined in real-time based on the available real-time and historical data and the quality of predictions. For example, where applicable, a subset of terms on the right-hand side of Equation (1) can be eliminated by setting the respective coefficient to zero. At 248, the control system 136 applies real-time simulation and statistical analysis such that the algorithm can predict the evolution of the vehicle states over the prediction horizon based on the assumed control inputs. At 252, the control system 136 evaluates the cost function/(e.g., solves or determines a minimum value of the cost function).

At 256, the control system 136 determines whether the route of the FCEV 100 is completed. When true, the method 200 ends. When false, the method 200 proceeds to 260. At 260, the control system 136 determines whether any major input(s) as previously described herein have changed. This could include, for example, determining whether any of the input(s) have changed by more than a respective threshold amount. When true, the method 200 returns back to 208 and the entire process repeats. When false, however, the method 200 proceeds to 264. At 264, the control system 136 updates the prediction horizon based on a portion of the route that the FCEV 100 has already traveled. At 268, the control system 136 solves the cost function and recalculates the control input trajectories. At 272, the control system 136 updates new control trajectories with those that were recalculated at 268 and the method 200 returns to 248 where the numerical and statistical analysis methods are again applied to predict the vehicle state evolution through the updated prediction horizon, after which the cost function is again evaluated (e.g., minimized) for optimal control or blending of the output power of the high voltage battery system 124 and the fuel cell system 128.

As discussed above, there could be various specific usage scenarios identified by the control system 136 at step 224. Each of these specific usage scenarios could further tune the blended output control of the high voltage battery system 124 and the fuel cell system 128. A first possible usage scenario is maximized regenerative braking capability. The algorithm uses information about the geographical location of the vehicle and the topology of its route to predict the future downhill movement of the FCEV 100. Similarly, using information about the route, such as the average speed and traffic information, the algorithm predicts the recoverable braking energy. Such predictions are applied in real-time to tune the cost function of Equation (1), specifically by increasing the weighting as and reducing the upper bound of the SOC,

$${ζ}_{max}^{*} .$$

As a result, leading up to the downhill segment of the route, the battery energy will be used progressively more and the fuel cell power will be minimized to reserve battery capacity to recover regenerative braking.

Another specific usage scenario is maintaining SOC for key-off functions, such as thermal conditioning, V2L, and vehicle-to-grid (V2G) function while avoiding negative impact on the vehicle drivability and unwanted fuel cell system wake-up. The algorithm utilizes information such as climatic condition, driver inputs (destination, departure time, scheduled conditioning, etc.) and component health states, to predict the need for key-off functions and the associated power requirement. Such predictions are applied on route to the destination to determine the required level of reserve SOC at the destination accordingly the parameters

$${ζ}_{f}^{*}$$

and α₇ in Equation (1) are adjusted. As a result, as the FCEV 100 approaches the destination, the power allocation between the battery and the fuel cell are adjusted to observe the reserve SOC limit.

Another specific usage scenario is optimizing V2L and V2H functions. From user inputs or historical data the algorithm predicts the required output power, duration of the functions, and required remaining vehicle range, information about the subsequent trip. The algorithm also uses additional information such as the location of the nearby battery charging stations and hydrogen fuel stations. Accordingly, the algorithm tunes the boundary limits of the cost function of Equation (1), in particular the minimum SOC

$${ζ}_{min}^{*} ,$$

the reserve SOC

$${ζ}_{f}^{*}$$

and the reserve hydrogen

$${LHT}_{f}^{*} ,$$

as well as the appropriate weighting factors. By solving the minimization problem, the algorithm finds the best power allocation strategy between the fuel cell and the battery that delivers the requested function in the most efficient manner while observing the boundary limits.

Another specific usage scenario is blending H2 and battery SOC based on availability of charging and refueling stations. The algorithm acquires real-time information about the location and availability of battery charging stations and H2 fuel stations along the vehicle route, from the respective stations or from the system of charge station or fuel station management (ref invention proposal: Intelligent system of coordinated EV charge management). In addition, the algorithm uses other real-time and historical information including about the operation of the vehicle, the route and the user inputs to balance battery charge usage and H2 usage. Accordingly, the algorithm will tune the factors α₁ and α₂ in Equation (1) and determines the controls commands that optimize the vehicle's energy efficiency and performance along the prediction horizon.

Yet another specific usage scenario is managing trade-off between fuel cell system warm-up and other thermal conditioning loads. The algorithm uses real-time and historical information such as energy consumption, driving patterns, route information, etc. to predict the need to start up the fuel cell. In addition, the algorithm uses the ambient temperature, as well as the temperature of the battery system 124, the fuel cell system 128, the cabin and other consumers of the thermal energy. Accordingly, the algorithm predicts the thermal energy requirement of starting up the fuel cell and predicts any trade-off between thermal management of the fuel cell and other thermal energy consumers. Accordingly, the algorithm will adjust the initiation and duration of fuel cell warm up to minimize any negative impact on the thermal management of other consumers while minimizing the total energy consumption. This is achieved by adjusting FCWU and its weighting factor α₆ in real-time based on ambient temperature, the thermal status of the fuel cell system 128 and that of other components.

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A predictive supervisory energy management system for a fuel cell electric vehicle (FCEV), the predictive supervisory energy management system comprising:
a set of sensors configured to monitor driver inputs to the FCEV, states of the FCEV, and external inputs affecting the FCEV along a defined route; and
a control system connected to the set of sensors and configured to:
predict energy consumption by a high voltage system of the FCEV across a future prediction horizon based on the driver inputs, the states of the FCEV, and the external inputs affecting the FCEV, the high voltage system comprising a high voltage battery system and a fuel cell system;
determine weighting factors and boundary conditions for a cost function for the energy consumption by the high voltage system of the FCEV;
evaluate the cost function based on the determined weighting factors, boundary conditions, and the predicted energy consumption by the high voltage system across the future prediction horizon; and
optimally control the fuel cell system and the high voltage battery system based on the evaluation of the cost function.

2. The predictive supervisory energy management system of claim 1, wherein the cost function is defined as follows:
$$J = \sum ( {α}_{1} {f}_{1} ( {P}_{b} ) + {α}_{2} {f}_{2} ( {P}_{fc} ) + {α}_{3} {f}_{3} ( {P}_{net} \cdot {P}_{EM}^{d} ) + {α}_{4} {f}_{4} ( ζ \cdot {ζ}_{min}^{*} ) + {α}_{5} {f}_{5} ( ζ \cdot {ζ}_{max}^{*} ) + {α}_{6} {f}_{6} ( FCWU ) ) Δ t + {α}_{7} {f}_{7} ( {ζ}_{f} \cdot {ζ}_{f}^{*} ) + {α}_{8} {f}_{8} ( {LHT}_{f} , {LHT}_{f}^{*} ) , \qquad ( 1 )$$
where J represents the cost function with weighting factors α₁ to α₈ for components f₁ to f₈, P_{b} and P_{fc} represent a battery terminal power and a fuel cell output power, respectively,
$${P}_{EM}^{d}$$
represents a desirable power of one or more electric motors of the FCEV, Pₙₑₜ represents a net power of the high voltage battery system, the fuel cell system, and a set of accessory systems, ζ represents a state of charge (SOC) of the high voltage battery system,
$${ζ}_{min}^{*} and {ζ}_{max}^{*}$$
represent target minimum and maximum bounds of ζ, FCWU represents a cost of waking up and thermally managing the fuel cell system, ζ_{f} and
$${ζ}_{f}^{*}$$
represent a final remaining SOC and its target, respectively, and LHT_{f} and
$${LHT}_{f}^{*}$$
represent a final remaining level of fuel cell system fuel and its target, respectively.

3. The predictive supervisory energy management system of claim 1, wherein the control system is configured to apply numerical and statistical methods to predict a vehicle state evolution through the future prediction horizon, wherein the predicted vehicle state evolution is used in the evaluating of the cost function.

4. The predictive supervisory energy management system of claim 1, wherein the driver inputs, the states of the FCEV, and the external inputs affecting the FCEV include both historical and real-time information.

5. The predictive supervisory energy management system of claim 4, wherein the driver inputs include (i) route plan, (ii) accelerator pedal position, (iii) vehicle stoppage intervals, (iv) accessory loads, (v) fuel cell system refueling and battery charging patterns, (vi) vehicle driving mode, (vii) departure time, (viii) scheduled charging, and (ix) scheduled conditioning.

6. The predictive supervisory energy management system of claim 4, wherein the states of the FCEV include (i) subsystem temperatures, (ii) subsystem efficiencies, (iii) remaining battery energy, (iv) battery state of health (SOH), (v) accumulated vehicle run time, (vi) accumulated vehicle energy consumption, and/or (vii) vehicle weight and payload.

7. The predictive supervisory energy management system of claim 4, wherein the external inputs affecting the FCEV include (i) geographical location, (ii) route topological information, (iii) climatic information, (iv) traffic information, and (v) location of battery charging and fuel cell system refueling stations.

8. The predictive supervisory energy management system of claim 1, wherein the control system is further configured to determine a usage scenario for optimally controlling the FCEV and the energy consumption prediction, the weighting factors and boundary conditions determination, and the cost function evaluation are all performed based on the determined usage scenario.

9. The predictive supervisory energy management system of claim 8, wherein the usage scenario is one of (i) maximizing regenerative braking capability, (ii) maintaining SOC for key-off functions, (iii) optimizing vehicle-to-load and/or vehicle-to-home functions, (iv) blending fuel cell system fuel and battery SOC based on availability of charging and refueling stations, or (v) managing trade-off between fuel cell system warm-up and other thermal conditioning loads.

10. A predictive supervisory energy management method for a fuel cell electric vehicle (FCEV), the predictive supervisory energy management method comprising:
monitoring, by a set of sensors of the FCEV, driver inputs to the FCEV, states of the FCEV, and external inputs affecting the FCEV along a defined route;
predicting, by a control system of the FCEV, energy consumption by a high voltage system of the FCEV across a future prediction horizon based on the driver inputs, the states of the FCEV, and the external inputs affecting the FCEV, the high voltage system comprising a high voltage battery system and a fuel cell system;
determining, by the control system, weighting factors and boundary conditions for a cost function for the energy consumption by the high voltage system of the FCEV;
evaluating, by the control system, the cost function based on the determined weighting factors, boundary conditions, and the predicted energy consumption by the high voltage system across the future prediction horizon; and
optimally controlling, by the control system, the fuel cell system and the high voltage battery system based on the evaluation of the cost function.

11. The predictive supervisory energy management method of claim 10, wherein the cost function is defined as follows:
$$J = \sum ( {α}_{1} {f}_{1} ( {P}_{b} ) + {α}_{2} {f}_{2} ( {P}_{fc} ) + {α}_{3} {f}_{3} ( {P}_{net} \cdot {P}_{EM}^{d} ) + {α}_{4} {f}_{4} ( ζ \cdot {ζ}_{min}^{*} ) + {α}_{5} {f}_{5} ( ζ \cdot {ζ}_{max}^{*} ) + {α}_{6} {f}_{6} ( FCWU ) ) Δ t + {α}_{7} {f}_{7} ( {ζ}_{f} \cdot {ζ}_{f}^{*} ) + {α}_{8} {f}_{8} ( {LHT}_{f} , {LHT}_{f}^{*} ) , \qquad ( 1 )$$
where J represents the cost function with weighting factors α₁ to α₈ for components f₁ to f₈, P_{b} and P_{fc} represent a battery terminal power and a fuel cell output power, respectively,
$${P}_{EM}^{d}$$
represents a desirable power of one or more electric motors of the FCEV, Pₙₑₜ represents a net power of the high voltage battery system, the fuel cell system, and a set of accessory systems, ζ represents a state of charge (SOC) of the high voltage battery system,
$${ζ}_{min}^{*} and {ζ}_{max}^{*}$$
represent target minimum and maximum bounds of ζ, FCWU represents a cost of waking up and thermally managing the fuel cell system, ζ_{f} and
$${ζ}_{f}^{*}$$
represent a final remaining SOC and its target, respectively, and LHT_{f} and
$${LHT}_{f}^{*}$$
represent a final remaining level of fuel cell system fuel and its target, respectively.

12. The predictive supervisory energy management method of claim 10, further comprising applying, by the control system, numerical and statistical methods to predict a vehicle state evolution through the future prediction horizon, wherein the predicted vehicle state evolution is used by the control system in the evaluating of the cost function.

13. The predictive supervisory energy management method of claim 10, wherein the driver inputs, the states of the FCEV, and the external inputs affecting the FCEV include both historical and real-time information.

14. The predictive supervisory energy management method of claim 13, wherein the driver inputs include (i) route plan, (ii) accelerator pedal position, (iii) vehicle stoppage intervals, (iv) accessory loads, (v) fuel cell system refueling and battery charging patterns, (vi) vehicle driving mode, (vii) departure time, (viii) scheduled charging, and (ix) scheduled conditioning.

15. The predictive supervisory energy management method of claim 13, wherein the states of the FCEV include (i) subsystem temperatures, (ii) subsystem efficiencies, (iii) remaining battery energy, (iv) battery state of health (SOH), (v) accumulated vehicle run time, (vi) accumulated vehicle energy consumption, and/or (vii) vehicle weight and payload.

16. The predictive supervisory energy management method of claim 13, wherein the external inputs affecting the FCEV include (i) geographical location, (ii) route topological information, (iii) climatic information, (iv) traffic information, and (v) location of battery charging and fuel cell system refueling stations.

17. The predictive supervisory energy management method of claim 10, wherein the control system is further configured to determine a usage scenario for optimally controlling the FCEV and the energy consumption prediction, the weighting factors and boundary conditions determination, and the cost function evaluation are all performed based on the determined usage scenario.

18. The predictive supervisory energy management method of claim 17, wherein the usage scenario is one of (i) maximizing regenerative braking capability, (ii) maintaining SOC for key-off functions, (iii) optimizing vehicle-to-load and/or vehicle-to-home functions, (iv) blending fuel cell system fuel and battery SOC based on availability of charging and refueling stations, or (v) managing trade-off between fuel cell system warm-up and other thermal conditioning loads.
